(19) United States
(12) Patent Application Publication
(10) Pub. No.: US 2017/0285578 A1
(43) Pub. Date: Oct. 5, 2017

(54) TACTILE METRONOME

(71) Applicant: Soundbrenner Limited, Hong Kong (HK)

(72) Inventors: Julian Vogels, Hong Kong (HK); Florian Simmendinger, Hong Kong (HK)

(73) Assignee: Soundbrenner Limited

(21) Appl. No.: 15/085,378

(22) Filed: Mar. 30, 2016

(51) Int. Cl. G04F 5/02

(52) U.S. Cl. CPC G04F 5/025

(57) ABSTRACT

A metronome capable of imparting a tactile sensation in order to assist the user in monitoring a tempo. The metronome is configurable to be worn on the wrist, chest, ankle or any part of the body most suitable for the user. The metronome may be provided as a kit including a removable metronome casing and a series of changeable belts for holding the casing to body parts of different thickness. The metronome can be in a group network of other metronomes. In one embodiment, each metronome in the group is commonly linked to a smartphone by Bluetooth, and the smartphone is useable to synchronize a plurality of metronomes wirelessly to play the same tempo. Each of the metronomes in the group can set the tempo for the entire group of metronomes. Advantageously, none of the metronomes is controlling, and any one of the metronomes can be used to set the tempo.

### FIELD OF THE INVENTION

The present invention relates to the field of metronome and particularly to tactile metronomes providing tempo which can be felt by a musician.

### BACKGROUND

Many musicians and students of music time their music practice using conventional metronomes. Typically, clockwork and a pendulum are provided inside such a metronome to keep a steady tempo as the musician plays. The difficulty with using this kind of metronome is that that it eventually stops and will require rewinding. It becomes annoying and disruptive if the metronome stops halfway through a practice. Another disadvantage of this kind of metronome is the lack of portability. Portability was not in the mind of instrument makers when the clockwork metronome was invented. However, as society and technology improve, people are travelling more often and over greater distances for music practice, i.e. at different homes, to schools and conservatories, and it would be preferable if the metronomes were portable so that a musician does not have to buy several ones. To resolve such problems, the electrical quartz metronome has been proposed. A quartz metronome is portable as it is generally small in size and is able count for a longer period of time than a clockwork metronome, due to battery power.

Both the quartz and the conventional metronome emit a loud, periodic ticking to help the musician keep to tempo. The musician plays as he listens to the beat determined by the ticking. Occasionally, the ticking is a source of a disturbance, such as when the musician is struggling to read a new score but is compelled by the ticking to keep up with the tempo.

Using an audible metronome requires a trained ear, which is a completely independent skill on its own, separate from the skills of playing an instrument and reading music. A musician gets better with playing music to a metronome over time but beginners tend to find it stressful and unnatural. For example, if the musician is not following the metronome, everyone within earshot can notice it, which imposes a pressure on the musician. Typically, a musician who has lost the tempo has to stop playing completely, listen to the metronome to get the tempo right before resuming playing; the musician cannot hide from the people around him that he is out of step with the metronome.

On the other hand, the ticking of such a metronome may be too soft in other situations. For example, a small group of musicians without guidance of a conductor, such as a small band or a quartet might need a metronome to guide their timing. However, they may not be able to hear the metronome as the ticking is easily drowned out by the music played.

To overcome disadvantages of an audible metronome, a tactile metronome has been proposed in expired U.S. Pat. No. 6,727,419 to allow musicians to keep to tempo without relying on an audible ticking. This tactile metronome has a wrist belt for strapping onto the wrist of a user such that it may be worn like a watch. The metronome imparts periodic vibrations against the wrist of the user to convey a regular beat which can be felt by the skin of the user. However, this metronome is usable only by the musician wearing it, and the tempo cannot be felt commonly by a group of musicians.

Another tactile metronome has been proposed in U.S. Pat. No. 7,390,955 that may be used by a group of musicians. Every musician in the group carries a tactile metronome. The tactile metronome comprises transducers in wireless communication with a remotely located signal generator. The signal generator is contained within a ‘base unit’. The base unit is under the centralized control of the group's conductor or lead musician. The base unit issues instruction to the tactile metronomes wirelessly so that the metronomes may provide a synchronized, non-audible, tactile tempo to all the musicians. However, U.S. Pat. No. 7,390,955 suffers from a disadvantage in that the base unit is critical for the whole group of musician to be able to synchronize their metronomes. The metronomes cannot be synchronized due to loss of central control if the base unit is lost or if the base unit has run out of power.

Similarly, U.S. Pat. No. 7,304,230 discloses a network of metronomes which can communicate with a single ‘multiple-channel metronome’ controlling several metronomes. In other words, the multiple-channel metronome is a ‘base unit’ for controlling metronomes. There is no disclosure of how the network of metronome may be synchronized if the multiple-channel metronome is lost or malfunctioning.

U.S. Pat. No. 7,422,564 discloses to a tactile rhythm generator for use by an athlete or a musician. However, this tactile rhythm generator requires the wearable tactile transducer to be structurally isolated from a rigid casing enclosing a signal generator. An electrical cable connects the casing to the wearable tactile transducer. U.S. Pat. No. 7,422,564 explains that the casing and the transducer are separated in order that vibrations intended to be felt by the user are not diminished by the rigid casing. However, the electrical cable hampers the user's movements and is unsightly, rendering the metronome especially unsuitable for a stylish band of musicians in live performance. Also, a ‘fastener’ required for holding the wearable tactile transducer in contact with the user reduces effective and intimate contact between the vibration transducer and the user's skin.

None of the prior art tactile metronomes or metronome systems described is suitable for vigorous musician activity, such counting tempo when being worn by a heavy metal drummer or a dancing musician. It is quite easy for tactile signals emitted by the prior art tactile metronomes to be drowned out by the movements of a musician or performer, or drowned out by vibrations from the instrument he is playing. As a result, the tactile tempo is not noticeable.

Accordingly, it is desirable to provide an improved metronome by which a plurality of musicians and the conductor are able to keep a synchronized tempo with each other. In particular, it is desirable to provide a metronome which may be used by a musician or performer in vigorous performance activity while playing an instrument.

### BRIEF SUMMARY

In a first aspect, the invention proposes a tactile metronome kit comprising a casing comprising a vibration generator, the vibration generator for imparting a tactile tempo to a user of the tactile metronome, and a set of changeable belts each having different belt lengths, each belt having a configuration suitable for removably holding the casing in order for strapping the casing to a body part of the user. Advantageously, the kit allows for different body parts to be tied with the tactile metronome, and the part of the body most suitable for a performance or the type of instrument played by the user may be selected.

Preferably, the tactile metronome kit comprises at least one belt having a length configured for strapping the casing to the chest of an adult user. This is particularly advantageous for percussionists such as a drummer, who might play drums with his hand vigorously and tactile sensation generated by a tactile metronome tied to his wrist or ankle might be drowned out by the vigorous movements of his limbs. The chest is relatively stable and does not affect the drummer from feeling the tempo generated by a tactile metronome.

In a second aspect, the invention proposes a metronome comprising a wireless transceiver for communicating with at least one other metronome, the metronome being capable of issuing instruction via the wireless transceiver to the at least one other metronome, the instruction relating to tactile signal to be generated in the at least one other metronome, and the metronome being capable of receiving instruction from the at least one other metronome relating to tactile signal to be generated in the metronome. Advantageously, this provides the possibility that any one in a group of metronomes is able to issue instruction relating to tempo to all the other metronomes in the group. If one of the metronomes is faulty or lost, the rest of the metronomes in the network will be able to synchronize tempo for the group of musicians. This feature is not limited to tactile metronomes and may be used even with non-tactile metronomes. However, preferably, the metronome comprises a tactile sensation generator to impart a tactile signal to a user.

Preferably, the metronome comprises a belt having a length suitable for use in strapping the metronome to the chest of the user. In addition to such a chest belt, a wrist belt and a belt for the upper arm or ankle are also within the contemplation of possible embodiments.

In one option, communication between any two metronomes is made directly between metronomes wirelessly. In another option, however, the metronome is capable of issuing instruction via the wireless transceiver to a smartphone, and the smartphone issues the instruction in turn to the at least one other metronome, and the metronome being capable of receiving instruction from the smartphone when the smartphone receives instruction from the at least one other metronome. The use of a smartphone as an intermediary between the metronomes allows communication technology in a smartphone to be used for managing a plurality of metronomes.

In a third aspect, the invention proposes a wearable tactile metronome capable of receiving instruction from a smartphone to generate a tactile tempo.

Preferably, the wearable tactile metronome is capable of issuing instruction to the smartphone, such that the smartphone forwards the instruction to another wearable tactile metronome in communication with the smartphone.

More preferably, the wearable tactile metronome is capable of issuing instruction to the smartphone, such that the smartphone forwards the instruction to another smartphone; and the other smartphone forwards the instruction to another wearable tactile metronome in communication with the other smartphone.

Therefore, a wearable tactile metronome is able to issue tempo instruction to a smartphone, which then forwards the instruction to another smartphone, to be in turn forwarded to another metronome. As communication technology such as Bluetooth technology has a limited capacity for the number of devices connectable to a smartphone while maintaining optimal performance, this provides an expandable network of wireless metronomes in communication with an instructing smartphone via one or more other smartphones. Each smartphone in the network forms a subnet including a separate subset of wireless metronomes.

In a fourth aspect, the invention proposes a smartphone configured to be capable of issuing tempo instruction wirelessly to a plurality of metronomes.

Preferably, the smartphone is also configured to be capable of issuing tempo instruction wirelessly to another smartphone, such that the other smartphone is capable of issuing tempo instruction wirelessly to another plurality of metronomes.

### BRIEF DESCRIPTION OF DRAWINGS

It will be convenient to further describe the present invention with respect to the accompanying drawings that illustrate possible arrangements of the invention, in which like integers refer to like parts. Other embodiments of the invention are possible, and consequently the particularity of the accompanying drawings is not to be understood as superseding the generality of the preceding description of the invention.

FIG. 1 shows a first embodiment of the invention;

FIG. 2 shows the embodiment of FIG. 1 from a different angle;

FIG. 3 shows the embodiment of FIG. 1 in a different configuration;

FIG. 4 shows the embodiment of FIG. 1 in yet a different configuration;

FIG. 5 is a schematic diagram of the internal modules of the embodiment of FIG. 1;

FIG. 6 shows a charging station for the embodiment of FIG. 1;

FIG. 7 shows the casing of the embodiment of FIG. 1 removed from its belt;

FIG. 8a shows the embodiment of FIG. 1 with an arm belt;

FIG. 8b shows the embodiment of FIG. 1 with a wrist belt;

FIG. 9 illustrates a drummer wearing a variation of the embodiment of FIG. 1 around his chest;

FIG. 10 illustrates variations of different lengths of changeable belts useable with the embodiment of FIG. 1;

FIG. 11 illustrates a network of inter-communicating embodiments of FIG. 1;

FIG. 12 is a schematic illustration of an interface in a smartphone useable to control the embodiment of FIG. 1;

FIG. 13 shows a variation of the embodiment of FIG. 1, in a network of inter-communicating smartphones with each a plurality of embodiments connected.

### DETAILED DESCRIPTION OF EMBODIMENTS

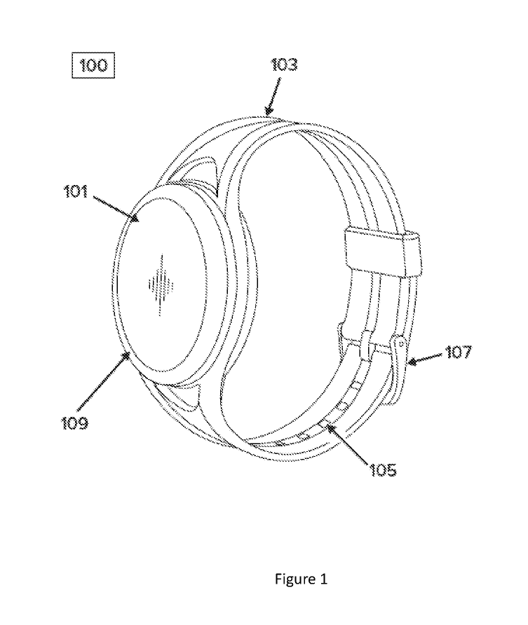

FIG. 1 shows a first embodiment 100 of the invention, which is a wearable metronome 100 capable or being belted or strapped onto a body part of a user. The embodiment comprises a casing 101 held in a belt 103. The belt 103 shown in FIG. 1 is a wrist belt 103 which allows the metronome 100 to be worn on the wrist of a user, like a watch.

The part of the belt 103 to one side of the casing 101 has a series of holes 105 along the length of that part. The other part of the belt 103 on the other side of the casing 101 has a buckle 107 at the end of the belt 103 for cooperating with any one of said holes 105. This allows the belt 103 to be strapped and buckled tightly to wrists of different sizes.

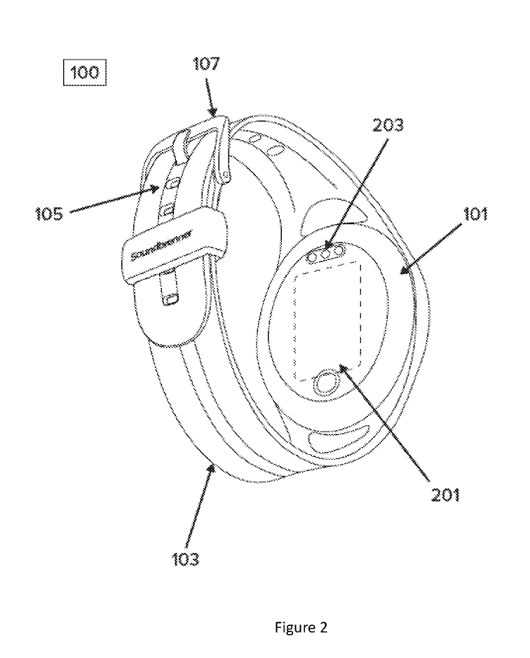

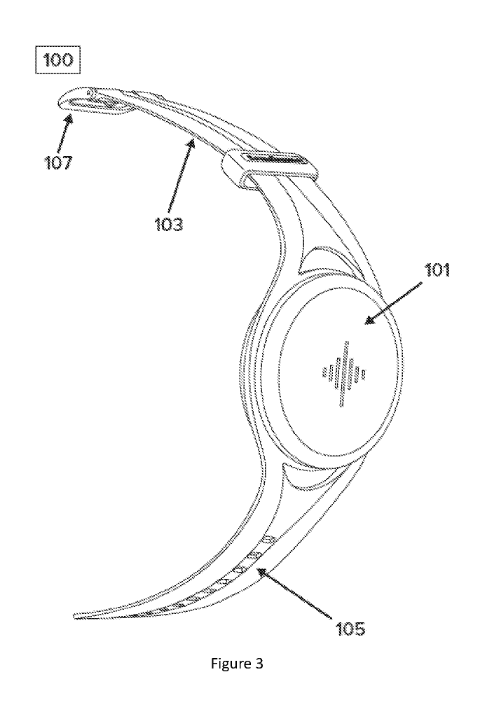

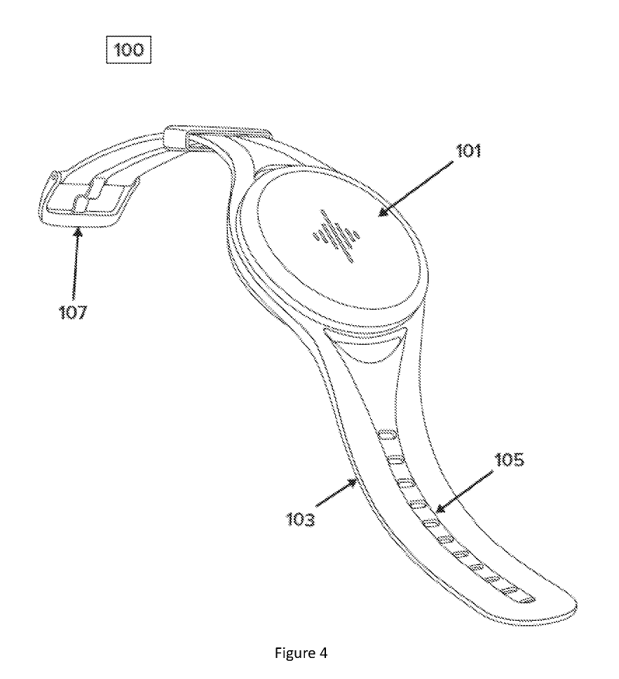

FIG. 2 shows the wearable metronome 100 in the closed-belt 103 configuration of FIG. 1 in a back view. The ‘back’ surface of the casing 101 is typically the surface held against the skin of the user when the metronome 100 is worn. FIG. 3 and FIG. 4 show the wearable metronome 100 in the open-belt 103 configuration from different angles.

Typically, the ‘back’ of the casing 101 has a somewhat planar surface which is suitable for being pressed against the selected body part. A tight or snug placement against the user is ensured by tying the belt 103 tightly around the selected body part. Although the body part which is suitable for the embodiment of FIG. 1 is the wrist, variations of the embodiment may be used on any other part of the body. A tight placement against the selected body part ensures that the user is able to feel vibration emitted via the planar surface of the casing 101 fully and clearly. In this way, the embodiment provides that the user is able to sense tempo played by the metronome 100 by his sense of touch without relying on audible clicking sound.

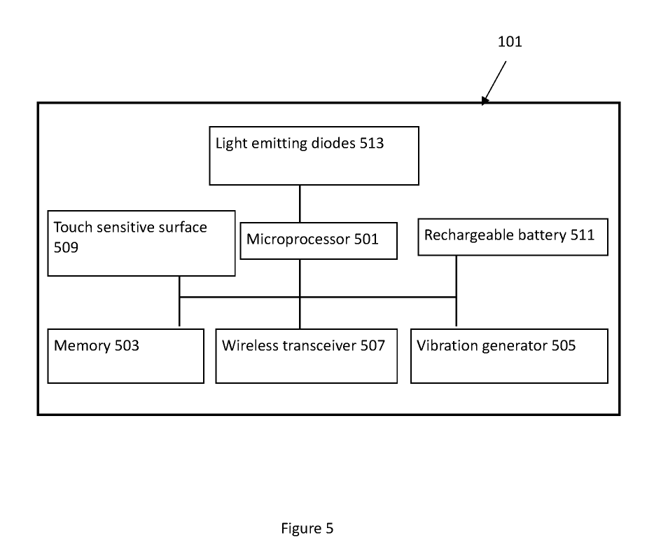

FIG. 5 is a schematic diagram of modules or parts inside the casing 101. The casing 101 may contain, among other things for example, a microprocessor 501, a memory 503, a vibration generator 505, a wireless transceiver 507 and a rechargeable battery 511.

Preferably, the vibration generator 505 is an advanced high-quality Eccentric Rotating Mass (ERM) vibration motor which is rated 7G.

Preferably, the rechargeable battery 511 is a lithium polymer battery and has a capacity of 330 mAh, which typically requires only 2.5 to 3 hours to be charged up fully.

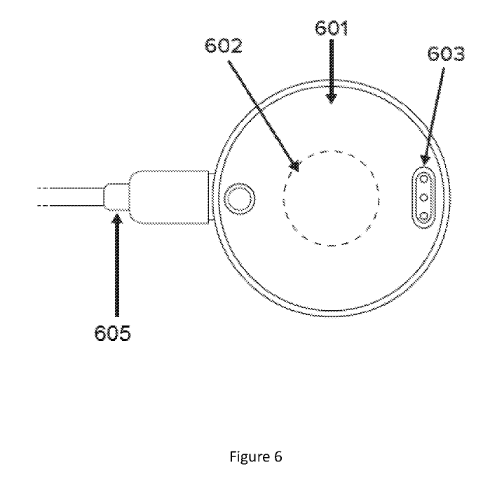

A charging station suitable for use with the embodiment of FIG. 1 is illustrated in FIG. 6. Typically, the charging station 601 is provided with a magnet 602 to which the casing 101 can be attached magnetically. Accordingly, the back of the casing 101 is provided with a metallic plate 201 (see FIG. 2) which can be guided by magnetic field emitted by the magnet 602 in the casing 101, so that charging terminals 603 on the charging station 601 may coincide with connection points 203 provided on the back of the casing 101 easily.

The charging station 601 typically has a Universal Micro USB socket to connect to a power supply by cable 605.

The memory 503 in the casing 101 contains software which is read by the microprocessor 501 in order to operate the vibration generator 505 and the wireless transceiver 507. The casing 101 is thereby controllable to issue a series of periodic vibrations which allows a user to sense tempo. It should be realized that the modules or parts shown in FIG. 5 can take different forms in actual hardware. FIG. 5 thus shows an example of such modules or parts, according to an embodiment. The microprocessor module or part 501 may include at least one signal processor that includes at least one central processing unit and the memory 503 may include a computer program that executes, at least in part, signal processing to control signalling. These processes may be expressed as a combination of computer instructions and data definitions that enable the processor to perform acts of computation and control. Thus, such instructions may take the form of software modules such as timing or tempo generating modules. Such software is sometimes referred to as comprising computer program code that likewise comprises computer instructions and data definitions expressed in a programming language or in a form output by an assembler, compiler, or other translator. A system comprising computer program code is thus able, together with at least one central processing unit, to cause the system at least to carry out certain process steps such as outlined in whole or in part herein. The methods shown herein may be coded by a computer programmer so as to express method steps in a programming language.

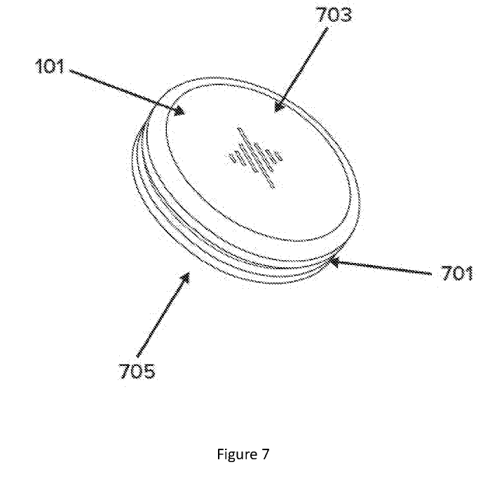

The casing 101 is typically shaped like a disc as shown in FIG. 7 and is removable from the belt 103. The circumference of the disc has an endless groove 701 which runs around the circumference of the casing 101. FIG. 7 illustrates the part of the casing 101 typically considered the ‘front’ by an arrow labelled 703 and the typically considered ‘back’ by the arrow labelled 705.

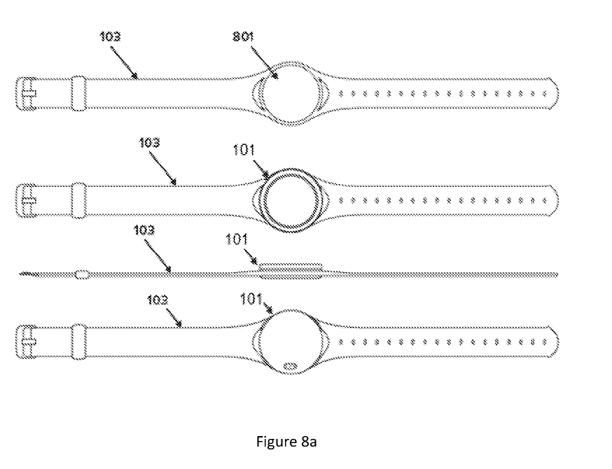

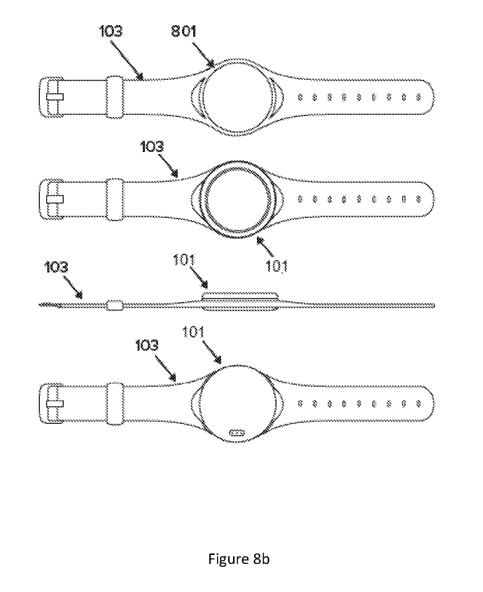

FIG. 8a illustrates the casing 101 and the belt 603 being removable from each other. In the top diagram of FIG. 8a, a belt which has not been set with a casing is illustrated. The belt 103 has a hoop 801 somewhat in the middle along the length of the belt 103. The hoop 801 is typically round and has a diameter slightly smaller than the diameter of the casing 101. The hoop 801 is preferably made of rubber or a similar material which is stretchable and resilient.

The second diagram in FIG. 8a from the top shows a casing 101 set into the belt 103. The casing 101 is assembled into the hoop 801 by stretching the hoop 801 over the casing 101 such that the hoop 801 snap fits into the groove 701 around the casing 101 circumference, and thereby holding the casing 101 in the belt 103 tightly.

The third diagram in FIG. 8a from the top shows a casing 101 set into the belt 103 and viewed from the side, while the bottom diagram in FIG. 8a shows a casing 101 set into the belt 103 and viewed from the back.

The casing 101 is removable from the belt 103 by pulling the casing 101 out of the stretchable and resilient hoop 801. The casing 101 can be re-fitted into another belt 103 having a hoop 801 of similar size, dimension and resilience. In this way, a plurality of changeable belts 103 having different lengths can be provided in order for the user to switch between different belts 103 according the size of the body part he wants to strap the metronome 100 onto.

FIG. 8b illustrates a similar metronome 100 as in FIG. 8a except that the belt 103 is shown having a shorter length.

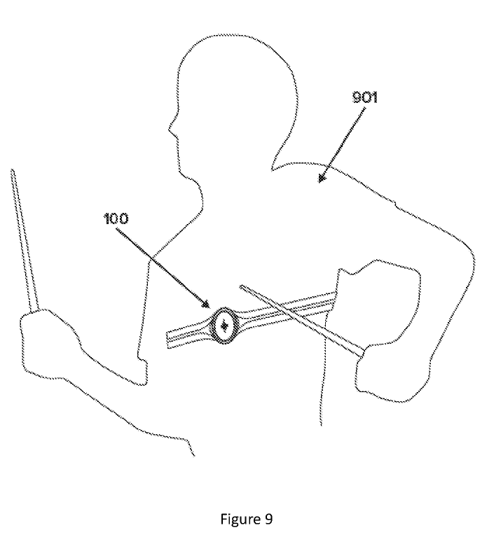

Accordingly, the wearable metronome 100 is provided in the form of a metronome kit comprising the casing 101 and a set of belts 103 which can be affixed interchangeably with the casing 101, and the belts 103 in the set each having a different length for tying to different parts of the body, including as the head (temple), neck, waist, wrist, ankle and so on, of the user. In one application, the casing 101 may be placed into a belt 103 suitable for strapping around the chest of the user. A chest strapped tactile metronome 100 is useful for musicians such as drummers who experience impact in their hands or feet as they play drums, such that any tactile sensation may be lost if they wore the wearable metronome 100 of FIG. 1 on their wrist or ankle. FIG. 9 illustrates how a tactile metronome 100 is worn around the chest of a drummer 901.

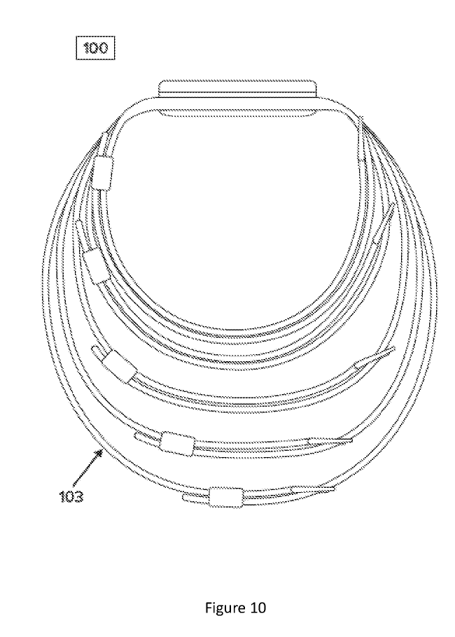

FIG. 10 is a picture showing different lengths of belts 103 which may be used to hold a casing 101 superimposed together.

Non-limiting examples of belt length for different body parts, or different ages and sizes of users, is shown below in a table.

| | for adult wrist or | Metric | English |
|---|---|---|---|
| Short strap | children's arm; | (centimeters) | (inches) |
| | length | 27.2 cm | 10.7″ |
| | width (band) | 2.3 cm | 0.91″ |
| | width (device) | 5.2 cm | 2.05″ |
| | min. arm circumference | 16 cm | 6.3″ |
| | max. arm circumference | 23.5 cm | 9.25″ |
| Long strap | for adult biceps or ankle; | | |
| | length | 44 cm | 17.32″ |
| | width (band) | 2.3 cm | 0.91″ |
| | width (device) | 5.2 cm | 2.05″ |
| | min. arm circumference | 24 cm | 9.45″ |
| | max. arm circumference | 41 cm | 16.14″ |

As the tabulated dimensions show, the belt 103 for an adult wrist may have a length of 27.2 cm or 10.7″, and a belt 103 for an adult bicep or ankle can be as long as 44 cm or 17.32″. Typically, the belt 103 for tying the casing 101 to a user's chest or waist can be 25″ to 50″.

Optionally, a touch sensitive surface 509 is provided on the ‘front’ of casing 101. The touch sensitive surface 509 is typically a capacitive sensor. To set tempo, the user simply taps onto the touch sensitive surface 509 with his finger in a regular motion. The microprocessor 501 reads and averages the period between the taps and instructs the vibration generator 505 to generate periodic vibrations of the same time period as the tapping. The user stops the vibration generator 505 by tapping again on the casing 101 surface, possibly by a quick double tap.

Optionally, one or more Light Emitting Diodes (LEDs) 513 is also provided in the casing 101 which can blink according to the tempo kept by the wearable metronome 100. Preferably, a set of LEDs in white, red, green and blue color is provided for variety, so that a selected color may be flashed when the metronome 100 is used in live performance for visual effect.

In the embodiment of FIG. 1, a translucent plastic ring 109 is illustrated on the casing 101 circumference. When an LED inside the casing 101 blinks, a blinking light is emitted from the casing 101 through the translucent ring 109, creating a blinking halo which draws the attention of the audience. This is a desirable visual effect when musicians in a group, such as a rock band, each wears an embodiment. The audience can enjoy the visual effect of the metronome 100 blinking synchronously as the musician themselves feel a synchronized tempo from the metronomes 100 they wear.

Furthermore, the LEDs can act as a supplementary cue to better follow the rhythm. For example, accented beats may be indicated by LEDs a different color from unaccented beats, which helps with the musicians to know visually where in a bar of written music score is the music currently being played.

Optionally, the LEDs can be switched off altogether if the musician prefers to conceal the metronome 100 in darkness on stage.

Preferably, the translucent plastic ring 109 on the casing 101 is rotatable, and rotating the ring 109 clockwise increases the tempo, and rotating the ring 109 anti clockwise decreases the tempo. Alternatively, rotating the ring 109 clockwise decreases the tempo, and rotating the ring 109 anti-clockwise increases the tempo. The mechanism of how the microprocessor detects and measures the extent of rotation of the ring 109 is known in the art, such as using a flick switch that establishes an electrical contact to one side or the other of the ring 109 as soon as it is flicked in either direction by teeth on the ring 109, and does not require elaboration here.

More specifically, in one embodiment, the touch sensitive surface 509 provides the following possible interactions:

1. When the user executes two quick consecutive taps (double tap) on the touch sensitive surface 509, the metronome 100 will start playing a tempo, or stop if the metronome 100 is already in operation.

2. If the user executes three or more consecutive taps, known as Tempotap, the metronome 100 averages at least two tapping intervals. Subsequently, the metronome 100 emits vibrations in a tempo according to the averaged interval.

3. If the user presses against the touch sensitive surface 509 for a period of time, known as a Long Tap, a light is emitted by a white LED inside the casing, which gets progressively stronger until the LED is emitting at maximum brightness, at which point the LED switches off suddenly. If the user releases his finger from the touch sensitive surface 509 at this point in time, the metronome 100 will be turned OFF.

4. If the user presses on the touch sensitive surface 509 as in step 3 but persists pressing even after the white LED has switched off, known as a Longer Tap, light will be emitted from a blue LED which also gets stronger progressively as the user continue pressing on the touch sensitive surface 509. Once the blue light is emitting at maximum brightness, the blue LED pulsates in a 3 second interval and the metronome 100 will enter a Bluetooth Search mode. In this mode, the metronome 100 disconnects from any already connected Bluetooth devices and will begin advertising its Bluetooth Services frequently which allows new connections to be made.

5. An alternative way to turn the device on, the user first turns the ring 109 in either the clockwise or anti-clockwise direction, and then tap and hold onto the touch sensitive surface 509. A white light is then emitted by the LED which intensifies progressively. At maximum intensity, the metronome 100 is switched ON.

6. As mentioned, the ring 109 is useable to adjust the tempo gradually by turning it clockwise to increase the tempo and counter-clockwise to decrease the tempo for example.

In a variation of the embodiment, the metronome 100 can also be registered with an application in a smartphone by over Bluetooth connection. The smartphone is useable to control the operation of the metronome 100 wirelessly, to start and stop the metronome 100, to set tempo and to set intensity of vibration from the metronome 100.

Furthermore, the smart phone can be used to turn on/off the LEDs on the device, as well as specify the color for each accent. (The vibration can also be specified per accent).

An application in the smartphone provides a modern and easy to use interface to manipulate and customize the metronome 100.

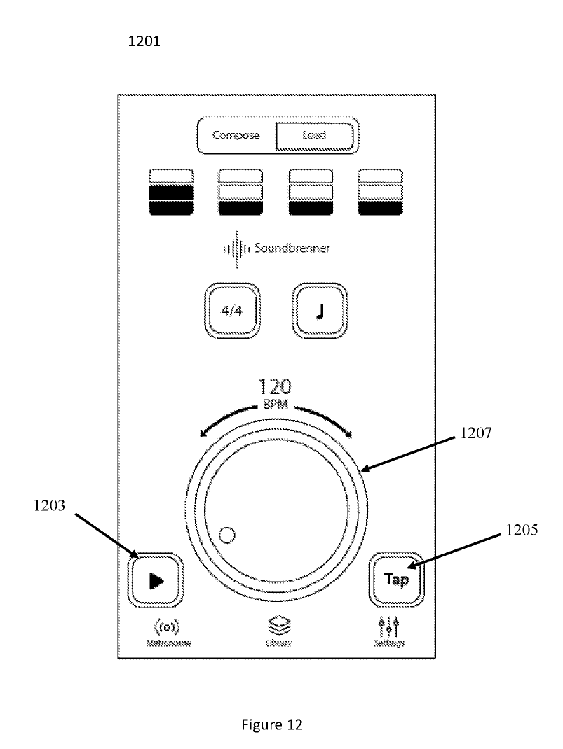

FIG. 12 shows one possible example of an interface of the application 1201 in a smartphone which may be used to control and synchronize the wearable metronomes 100.

The interface is displayed on a smartphone screen and includes, among other things, a START button 1203, a TAP button 1205, and a wheel 1207.

Pressing on the START button 1203 causes the metronome 100 to start issuing tactile signals to give a tempo. Tapping three or more times on the TAP button causes the smartphone to count the average interval between every two taps, and adjust the metronome 100 to play a tempo in the averaged interval.

The user can brush his thumb along the graphical wheel 1207 to change the tempo of the metronome 100. For example, brushing the thumb along the wheel 1207 in the anti-clockwise direction will slow down the tempo emitted by the metronome 100, while in the clockwise direction will speed up the tempo emitted by the metronome 100.

The tempo is reflected numerically as a beats per minute (BPM) information shown right above the wheel 1207.

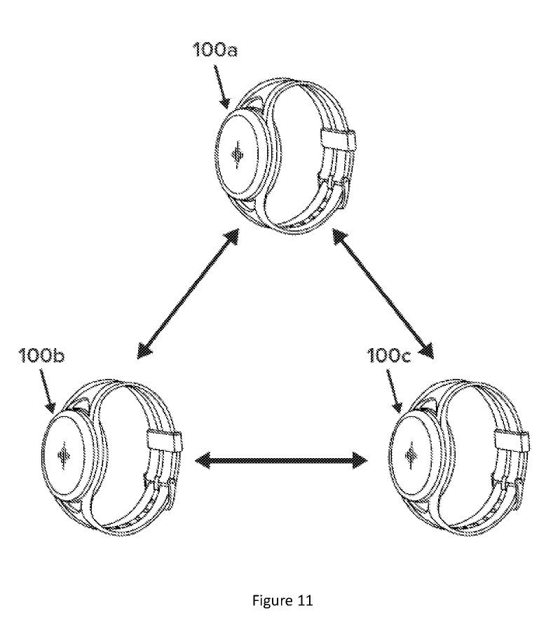

FIG. 11 shows another embodiment in which a plurality of wearable metronomes 100a, 100b, 100c are synchronized. Only three metronomes 100 are illustrated in FIG. 11 although the number of metronomes 100 in the network may be as many as current communication technology allows. Each of the metronomes 100 is in bi-directional communication with every other metronome 100 in the group of metronomes 100, as illustrated by the double-headed arrows. Any one of the metronomes 100 in FIG. 11 may set the tempo for all the other wearable metronomes 100. To do so, one of the users wearing one of the metronomes 100a, 100b, 100c taps on his own metronome 100 to set the tempo. Upon establishing the tempo, the metronome 100 then sends information of the tempo to the other wearable metronomes 100 within the same network, so that all the users can feel the same tempo.

As any one of the metronomes 100 in FIG. 11 can function as the instructing metronome 100, or a base unit, there is little problem for a band of musicians to synchronize all of their personal tactile metronomes 100 if any one of the metronomes 100 malfunctions or is lost. This is advantageous over prior art which relies on a specific base unit for controlling all the metronomes 100, which could render all the metronomes 100 without synchronization if the base unit is lost or not working.

During practice, the weakest player in the group of musicians may set the tempo for the entire group, in order that all the musicians may play according to his preferredtempo. If a base unit is used, as in the prior art, only the conductor or the lead musician can set the tempo, causing the weaker player to be forced to practice at a tempo much too quick for him.

Such a network of synchronized tactile metronomes 100 finds many uses and applications. For example, in a studio where musicians are separately recording different parts of a single piece of music and who are located in separate sound-proof cubicles, a system of wirelessly synchronized metronomes 100 provide a common tempo which can help the musicians to play in the correct tempo. Furthermore, a small marching band can be synchronized now without needing a marching drum. This effectively expands the types and variety of music which may be played by a marching band, as it frees the band from requiring a drum every time the band marches. In many pieces of music, a long pause may be required without accompanying percussion, which is a test of the consistency in mental beat counting for all the musicians in the band. It is very difficult not to count too quickly or too slowly if the pause is particularly long. The described network of tactile metronomes 100 allows the entire band to keep to the same tempo when counting down the pause, without needing a drummer or a conductor and yet be able to count the beat correctly together.

Unlike in the prior art, the various configurations of the embodiment as described can be hidden under the sleeves, the shirts or other clothing worn by the musicians, and there is no cable which is required for transmitting information from a centralized processing casing 101 to a vibrating device, such as the one described in FIG. 2 in U.S. Pat. No. 7,422,564. This effectively frees up musicians wearing the metronome 100 of this embodiment to walk, move and dance along with their music, without the hamper of a cable dangling from them. In other words, the embodiment 100 is configured to be worn by a user in a body hugging manner, as there is no trailing or loose part which dangles from the user's belt 103 and which could get in the way of the user's movements, or which may be seen easily if worn under clothing. For this purpose the parts as illustrated schematically in FIG. 5 are preferably provided in an integrated manner, such as being contained in the casing 101 as shown in FIG. 1.

Typically, the wearable metronomes 100 are enjoined into the same network by mutual Bluetooth advertisement and registration. However, as the skilled person knows, many other ways and technologies can be used to establish a network of wearable metronomes 100 and these are within the contemplation of this embodiment.

In terms of metronome 100 functionality, one of three accents can be chosen for each vibration beat emanating from the metronome 100. A rhythmic subdivision, e.g. two eighth notes, or a triplet, or a combination of sixteenth notes and rests, can be assigned to all the beats at once. The length of each period corresponding to a musical score bar can be selected between a range of 1 to 16 beats. These variations can be saved as a specifically defined rhythm in a list. Such a list is called setlist and can be organized like a music playlist and loaded onto the smartphone. It is then easy to switch back and forth between different stored rhythms.

Furthermore, the smartphone is capable of updating firmware in the memory 503 inside the metronome 100. If there are new features developed for the metronome 100, the user can perform a firmware update to gain access to those new features.

In a variation of the embodiments, communication for tempo synchronization between metronomes 100 may be done via the smartphone application 1201 instead of directly between metronome 100-to-metronome 100. For example, any one of the wearable metronomes 100 can issue instruction to all the other wearable metronomes 100 by first issuing instruction to the smartphone, which will then forward the instruction to all the metronomes 100 registered with the smartphone. Again, the technology used is preferably Bluetooth technology, particular Bluetooth Low Energy (Bluetooth LE, or Bluetooth Smart). Advantageously, as smartphones are common, it is possible for one smartphone to have malfunctioned and another smartphone be used instead to manage synchronization of the metronomes 100, such as by re-registering the metronomes 100 with the other smartphone.

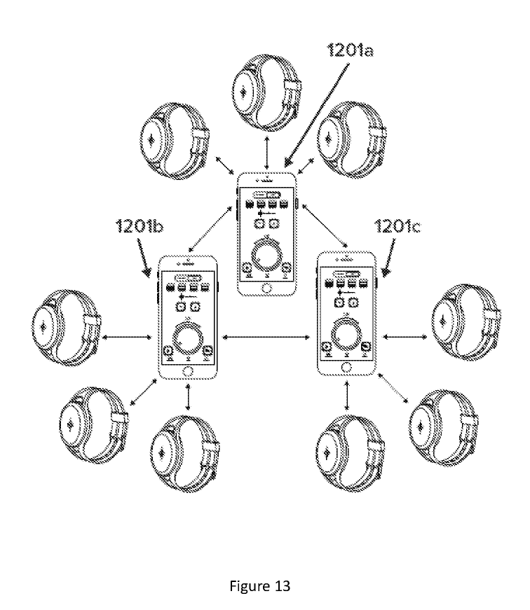

Although Bluetooth Low Energy does not limit the maximum number of connectable devices to a smartphone, technically it is only possible to connect up to 10 devices. The connection becomes somewhat unstable if more than four devices are connected at the same time. Therefore, in yet another variation of the embodiment shown in FIG. 13, multiple smartphones (shown displaying the application 1201a, 1201b, 1201c) can be used to synchronize an enlarged network of metronomes 100, each smartphone being registered with several metronomes 100 instead of all metronomes 100, and each smartphone being in communication with at least one other smartphone to ensure that communication between all the metronomes 100 are possible. This embodiment will allow metronomes 100 over a large physical distance to be synchronized. Thus, each smartphone is associated with a subset of only several smartphones of the enlarged network to form a subnet thereof.

While there has been described in the foregoing description various embodiments of the present invention, it will be understood by those skilled in the technology concerned that many variations or modifications in details of design, construction or operation may be made without departing from the scope of the present invention as claimed.

For example, the memory 503 in the casing 101 can be an on-board memory which is part of the microcontroller chip.

The vibration generating technology could be replaced by a Linear Resonant Actuator (LRA) vibration motors, or piezoelectric technology.

Where a smart phone has been mentioned, it can be replaced by other devices having similar computing and communication functions, such as a computer notebook or a desktop computer and so on.

1. A tactile metronome kit comprising
a casing comprising a vibration generator;
the vibration generator for imparting a tactile tempo to a user of the tactile metronome; and
a set of changeable belts each having different belt lengths, each belt having a configuration suitable for removably holding the casing in order for strapping the casing to a body part of the user.

2. A tactile metronome kit as claimed in claim 1 comprising at least one belt having a length configured for strapping the casing to the chest of an adult user.

3. A metronome, comprising
a wireless transceiver for communicating with at least one other metronome;
the metronome being capable of issuing instruction via the wireless transceiver via an intermediary smartphone to at least one other metronome, the instruction relating to a tactile signal to be generated in the at least one other metronome; and
the metronome being capable of receiving instruction over the intermediary smartphone from the at least one other metronome relating to the tactile signal to be generated in the metronome.

4. A metronome as claimed in claim 3, wherein
the metronome comprises a tactile sensation generator to impart a tactile signal to a user.

5. A metronome as claimed in claim 3 wherein
the metronome comprises a belt having a length suitable for use in strapping the metronome to the chest of the user.

6. A metronome as claimed in claim 3 wherein
the metronome is capable of issuing instruction via the wireless transceiver to a smartphone, and the smartphone issues the instruction in turn to the at least one other metronome; and
the metronome being capable of receiving instruction from the smartphone when the smartphone receives instruction from the at least one other metronome.

7. A wearable tactile metronome comprising a wireless transceiver for receiving instruction from a smartphone to generate a tactile tempo.

8. A wearable tactile metronome as claimed in claim 7 wherein
the wireless transceiver is for issuing instruction to the smartphone,
the instruction being for another wearable tactile metronome in communication with the smartphone to generate a tactile tempo.

9. A method of issuing instruction to a tactile metronome comprising the steps of:
providing the tactile metronome;
the tactile metronome issuing instruction to a smartphone wirelessly;
the smartphone forwarding the instruction to another wearable tactile metronome in communication with the smartphone to generate a tactile tempo.

10. (canceled)

11. (canceled)

12. The method of claim 9 wherein the step of the smartphone forwarding the instruction to another wearable tactile metronome in communication with the smartphone to generate a tactile tempo comprises the following steps:
the smartphone forwarding the instruction to another smartphone; and
the other smartphone forwarding the instruction to the other wearable tactile metronome in communication with the other smartphone.
